(19) United States
(12) Patent Application Publication
(10) Pub. No.: US 2026/0364497 A1
(43) Pub. Date: Nov. 19, 2026

(54) REFRIGERATOR APPLIANCE AND WATER FILTER ASSEMBLY

(71) Applicant: Haier US Appliance Solutions, Inc., Wilmington, DE (US)

(72) Inventors: Gregory Sergeevich Chernov, Louisville, KY (US); Thomas Earl McKeehan, JR., Crestwood, KY (US)

(21) Appl. No.: 19/209,887

(22) Filed: May 16, 2025

(51) Int. Cl. B01D 35/30; C02F 1/00; F25D 23/12

(52) U.S. Cl. CPC B01D 35/30; C02F 1/001; F25D 23/126; B01D 2201/30; B01D 2201/4023; B01D 2201/4061; C02F 2201/004; C02F 2201/006; C02F 2307/12; F25D 2323/121

(57) ABSTRACT

A refrigerator appliance includes a cabinet and a manifold mounted within the cabinet. The manifold includes a latch and a fluid port at a first end of the manifold. The latch includes a biasing element. A filtration housing is configured to couple to the manifold. The filtration housing includes a ridge and a shoulder at first end of the filtration housing. The latch of the manifold engages the ridge of the filtration housing in a first position securely mounting the filtration housing within the cabinet. The filter housing is configured to translate from the first position to a second position. The latch of the manifold engages the shoulder of the filtration housing in the second position, whereby the latch overcomes a center of the biasing element, positioning the latch in an open position, and freeing the filtration housing from the manifold.

### FIELD OF THE INVENTION

The present subject matter relates generally to refrigerator appliances, and more particularly to a system for installing and removing a water filtration assembly in a refrigerator appliance.

### BACKGROUND OF THE INVENTION

Refrigerator appliances generally include a cabinet that defines a chilled chamber. A wide variety of food items may be stored within the chilled chamber. The low temperature of the chilled chamber relative to ambient atmosphere assists with increasing a shelf life of the food items stored within the chilled chamber. Refrigerator appliances may also be equipped with a dispensing system. Such dispensing systems typically provide chilled water and/or ice from inside of the refrigerator appliance to a dispensing outlet accessible from inside or outside of the refrigerator appliance.

Certain refrigerator appliances further include water filter assemblies for filtering water. Water filter assemblies can filter water entering the refrigerator appliances to provide filtered water to various refrigerator appliance components, such as an ice maker and/or a water dispenser of the aforementioned dispensing system. Such filtering can improve a taste and/or an appearance of water within the refrigerator appliances.

Certain water filter assemblies can be difficult for a user to install or replace, and insecure/incomplete installation or replacement of the filter assembly can have undesired effects, such as user dissatisfaction and/or leakage. For example, aligning the filter assembly in a particular orientation during installation or replacement may be difficult in some limited visibility areas within the refrigerator appliance. In general, leaking water can lead to water damages to the surrounding environment where the refrigerator appliance is positioned, such as a kitchen of a residential home or commercial workspace.

Accordingly, a refrigerator appliance which includes a water filter assembly to obviate some of the above issues of refrigerator appliances would be beneficial and advantageous. In particular, a water filter assembly to simplify installation or replacement of the filter assembly would be particularly beneficial.

### BRIEF DESCRIPTION OF THE INVENTION

Aspects and advantages of the invention will be set forth in part in the following description, or may be obvious from the description, or may be learned through practice of the invention.

In one example embodiment, a refrigerator appliance is provided. The refrigerator appliance defines a vertical direction, a lateral direction, and a transverse direction. The vertical, lateral, and transverse directions are mutually perpendicular. The refrigerator appliance includes a cabinet, a dispensing assembly, and a manifold mounted within the cabinet. The manifold is fluidly coupled to the dispensing assembly and includes a latch and a port at a first end of the manifold. The latch includes a biasing element. A filtration housing is configured to couple to the manifold. The filtration housing includes a ridge and a shoulder at first end of the filtration housing. The latch of the manifold engages the ridge of the filtration housing in a first position securely mounting the filtration housing within the cabinet. The filter housing is configured to translate from the first position to a second position. The latch of the manifold engages the shoulder of the filtration housing in the second position, whereby the latch overcomes a center of the biasing element, positioning the latch in an open position, and freeing the filtration housing from the manifold.

In another example embodiment, a refrigerator appliance is provided. The refrigerator appliance includes a cabinet and a manifold mounted within the cabinet. The manifold includes a latch and a port at a first end of the manifold. The latch includes a biasing element. A filtration housing is configured to couple to the manifold. The filtration housing includes a ridge and a shoulder at first end of the filtration housing. The latch of the manifold engages the ridge of the filtration housing in a first position securely mounting the filtration housing within the cabinet. The filter housing is configured to translate from the first position to a second position, the latch of the manifold engages the shoulder of the filtration housing in the second position, whereby the latch overcomes a center of the biasing element, positioning the latch in an open position, and freeing the filtration housing from the manifold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides an elevation view of a refrigerator appliance according to example embodiments of the present disclosure.

FIG. 2 provides a perspective view of the example refrigerator appliance of FIG. 1.

FIG. 3 provides an elevation view of the example refrigerator appliance of FIG. 1, wherein the doors are shown in an open position.

FIG. 4 provides a simplified side elevation view of an embodiment of a water filtration assembly within a refrigerator appliance according to example embodiments of the present disclosure.

FIG. 5A provides a perspective view of a water filtration assembly according to aspects of the present subject matter.

FIG. 5B provides a perspective view of the water filtration assembly of FIG. 5A, including an illustration of a water filter disconnected from a portion of the water filtration assembly.

FIG. 6 provides an exploded perspective view of the example water filtration assembly of FIG. 5A.

FIG. 7A provides a side view of the water filter of the example water filtration assembly of FIG. 5A.

FIG. 7B provides a cross-sectional view of the water filter of the example water filtration assembly of FIG. 5A.

FIG. 7C provides an exploded view of the water filter of the example water filtration assembly of FIG. 5A.

FIG. 8 provides a perspective view of an example latch of the example water filtration assembly of FIG. 5A.

FIG. 9A provides a perspective view of the latch of FIG. 8.

FIG. 9B provides a side view of the latch of FIG. 9A.

FIG. 9C provides a side, section view of the latch of FIG. 9B.

FIG. 10 provides a perspective view an alternative embedment of the example water filtration assembly of FIG. 5A.

FIG. 11A provides a side view of an example filtration housing before installing into an example manifold according to aspects of the present subject matter.

FIG. 11B provides a side view of the example filtration housing of FIG. 11A in a first position.

FIG. 11C provides a side view of the example filtration housing of FIG. 11A in a second position.

FIG. 11D provides a side view of the example filtration housing of FIG. 11A being removed from the example manifold.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “example” is used herein to mean “serving as an example, instance, or illustration.” In addition, references to “an embodiment” or “one embodiment” does not necessarily refer to the same embodiment, although it may. Any implementation described herein as “example” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

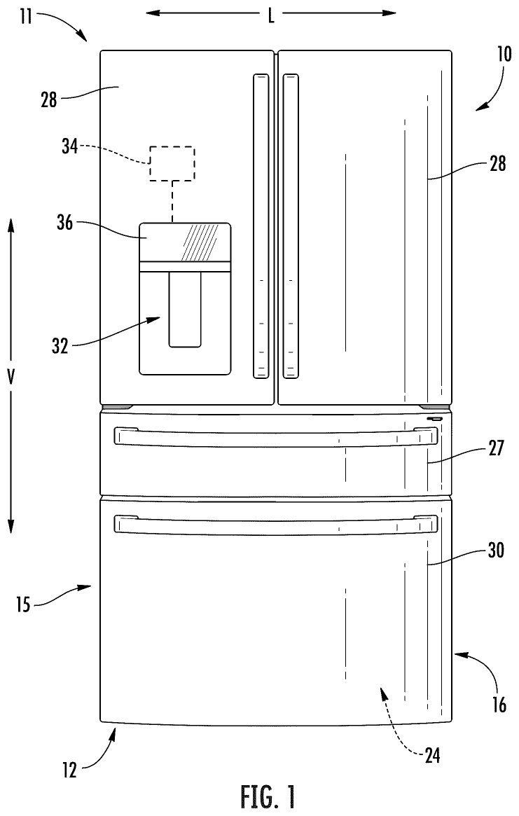

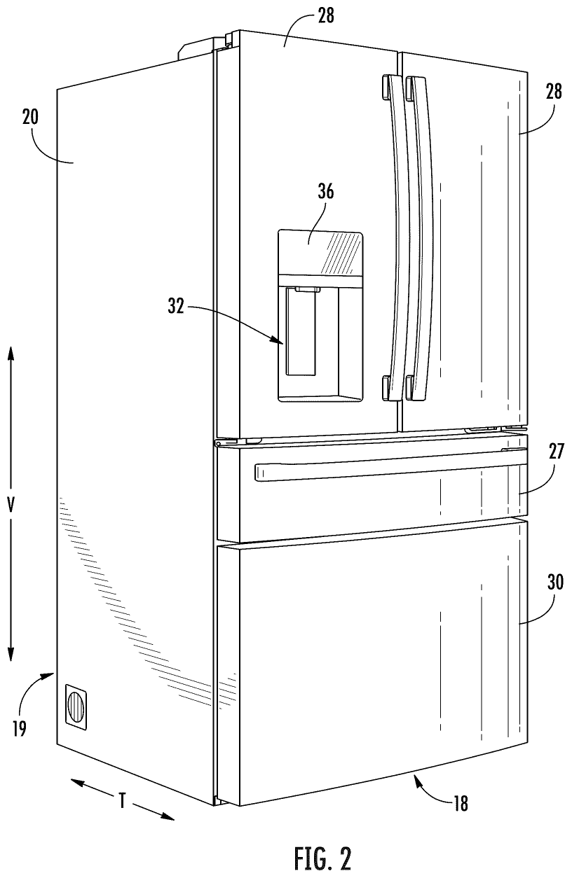

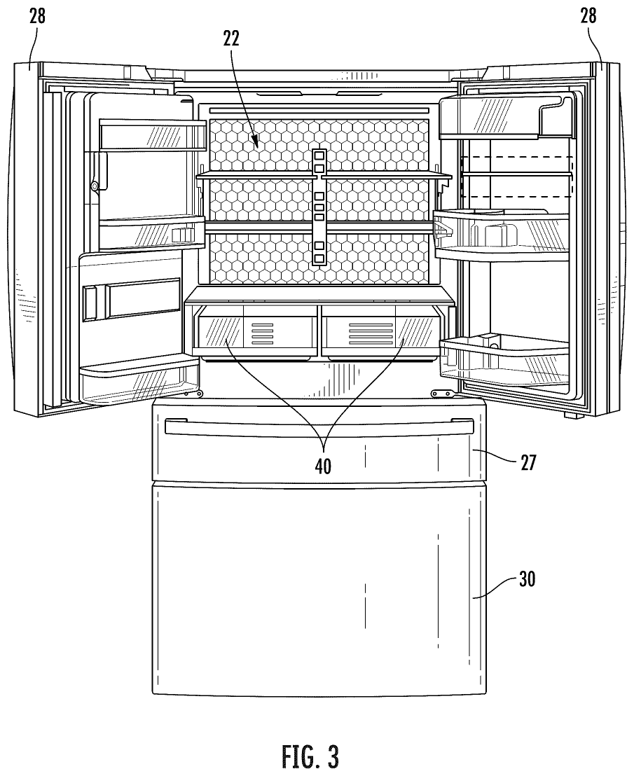

Referring now to the figures, FIG. 1 illustrates a front view of an embodiment of a refrigerator appliance 10 according to the present disclosure. FIG. 2 illustrates a perspective view of the refrigerator appliance 10 of FIG. 1. FIG. 3 illustrates a front view of the refrigerator appliance 10 of FIG. 1 with refrigerator doors 28 in an open position. Referring particularly to FIG. 1, the refrigerator appliance 10 extends between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

The controller 34 may include a memory and one or more microprocessors, CPUs, or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical, or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

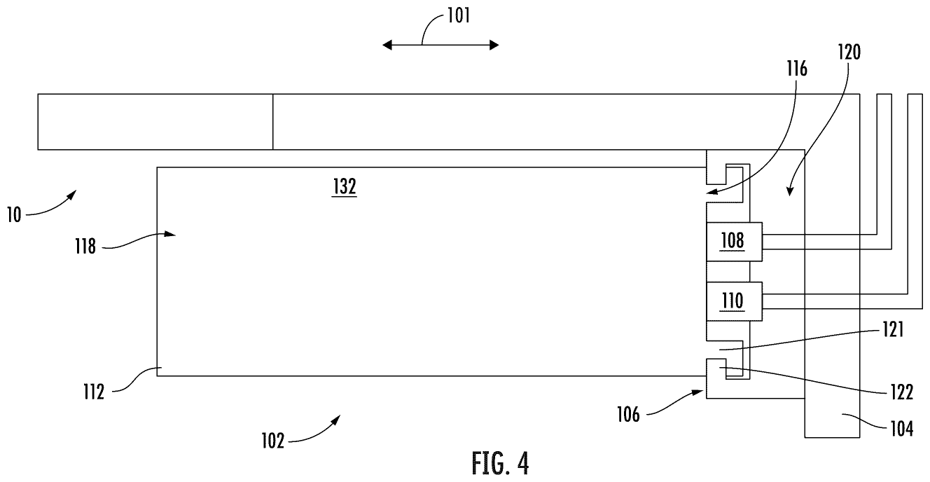

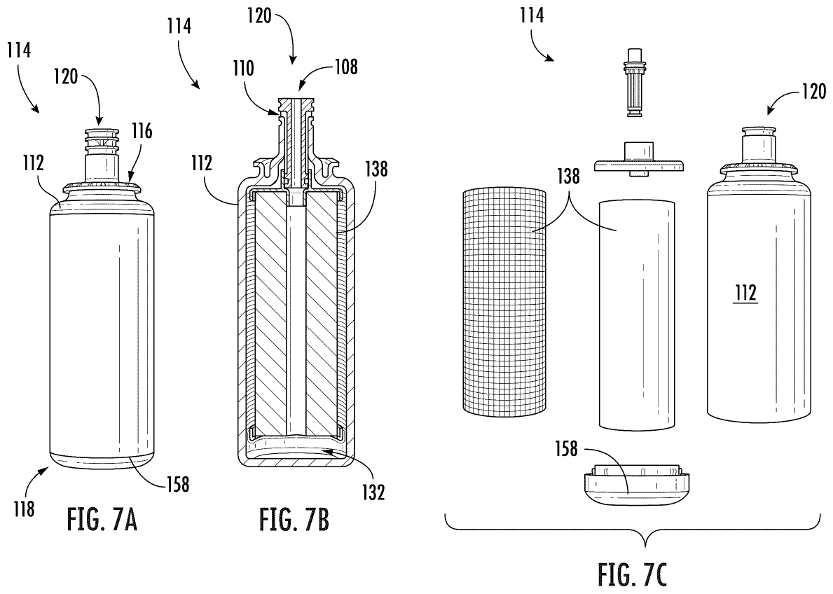

Referring now to FIG. 4, a simplified, schematic view of an embodiment of an appliance wall 104 of appliance 10 (such as an interior wall, an exterior wall, a side wall, etc.) having a water filtration assembly 102 secured thereto is illustrated. In particular, as shown, the water filtration assembly 102 has a filtration housing 112. As would be understood, a volume or mass of filtration media (e.g., water filtration cartridge 138, such as depicted in FIGS. 7B and 7C) may be disposed within the filtration housing 112. Optionally, the filtration housing 112 may have a cylindrical configuration. In further embodiments, the filtration housing 112 may have any other suitable configuration other than a cylindrical configuration. Moreover, as shown, the water filtration assembly 102 may also include a liquid receiving space 132 within the filtration housing 112.

In further embodiments, as shown, the water filtration assembly 102 includes a manifold 106 that may be mounted to appliance wall 104 of appliance 10. Accordingly, as shown, the manifold 106 may generally contain a filter latching/mating interface, as will be described in greater detail below, and water connections therein. For example, manifold 106 may generally be fluidly coupled to various components or systems within refrigerator appliance 10, such as dispenser assembly 32 and/or one or more ice making appliances (not shown).

Generally, and as would be understood, the appliance 100 includes a water source (not shown) that provides water to and from the water filtration assembly 102 (e.g., through the manifold 106 from one or more filter port 120 via a water inlet 108 and a water outlet 110, such as depicted in FIG. 4). Thus, in certain embodiments, the water filtration assembly 102 is in fluid communication with the water inlet 108 and the water outlet 110. It is noted that although FIG. 4 illustrates a simplified view whereby the water inlet 108 and water outlet 110 are spaced apart (e.g., at the same end of filtration housing 112), alternative embodiments may provide a coaxial inlet-outlet configuration, or other suitable configuration for a separate inlet and outlet for a filtration assembly, as would be understood.

The filtration housing 112 includes a first end 116 opposite a second end 118. In optional embodiments, the first end 116 includes one or more features for securing the water filtration assembly 102 to the manifold 106 via the filter latching/mating interface. For instance, the filter latching/mating interface may include the first end 116 of the filtration housing 112 having a ridge 121 and corresponding latches 122 of the manifold 106. In some such embodiments, the ridge 121 of the first end 116 of the filtration housing 112 may be configured to engage with the corresponding latch 122 of the manifold 106 for securing filtration housing 112 to the appliance 10, as will be described in greater detail below.

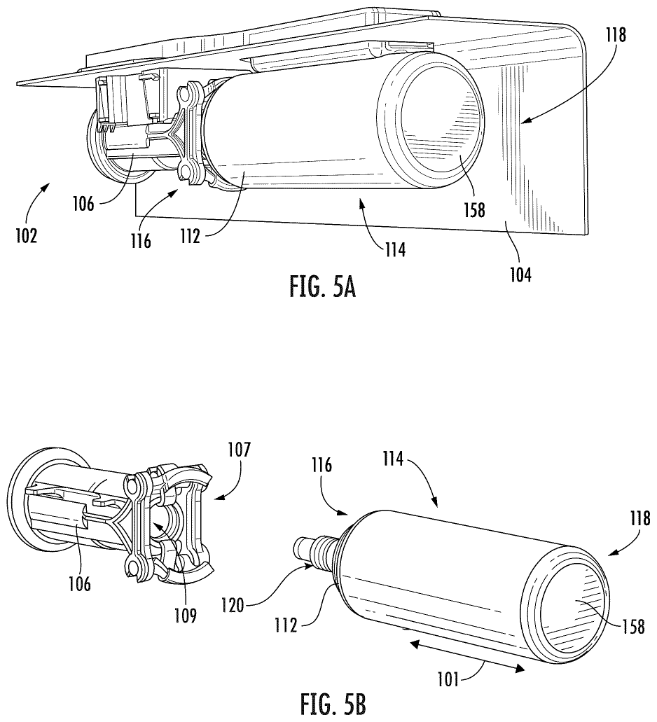

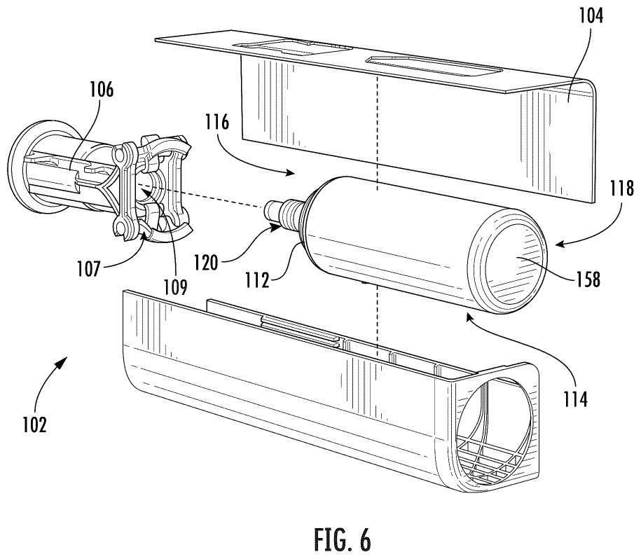

Referring specifically to FIGS. 5A, 5B, and 6, provided are perspective views of an example embodiment of a water filtration assembly. For example, FIG. 5A includes an illustration of water filtration assembly 102, FIG. 5B provides a perspective view of water filtration assembly 102 where a water filter 114 is disconnected from manifold 106 of water filtration assembly 102, and FIG. 6 provides an exploded perspective view of water filtration assembly 102 and portions of appliance wall 104. In general, filter 114 may include filter port 120 at first end 116 of filtration housing 112 and a housing cap 158 at second end 118 of filtration housing 112. In general, housing cap 158 may be selectively removable from filtration housing 112 in order to provide selective access to internal components of filter 114, as described further below.

Turning to FIGS. 7A, 7B, and 7C, various side views of water filter 114 of the example water filtration assembly 102 are provided. In particular, FIG. 7A provides a side view of water filter 114, FIG. 7B provides a cross-sectional side view of water filter 114, and FIG. 7C provides an exploded view of water filter 114. As stated above, filter 114 may include a volume or mass of filtration media, e.g., water filtration cartridge 138, within the filtration housing 112. In general, water filtration cartridge 138 may be positioned within liquid receiving space 132, e.g., defined between filter port 120 and housing cap 158, of filtration housing 112. For example, filtration cartridge 138 may be any suitable medium for filtering water, such as carbon, sand, or membrane structures.

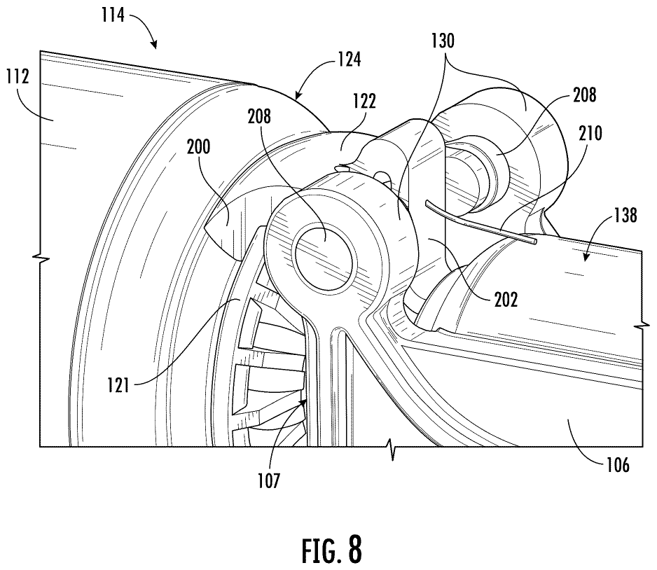

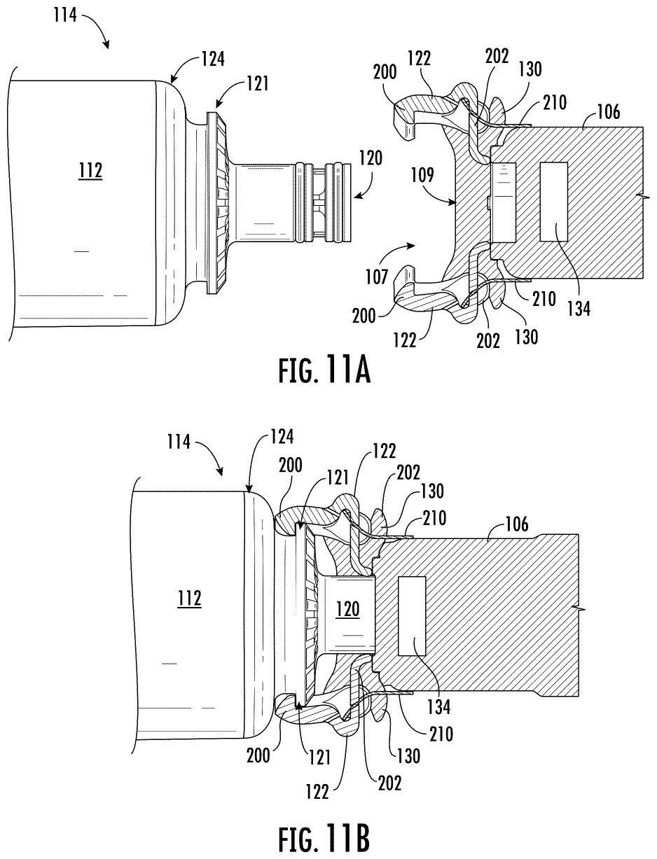

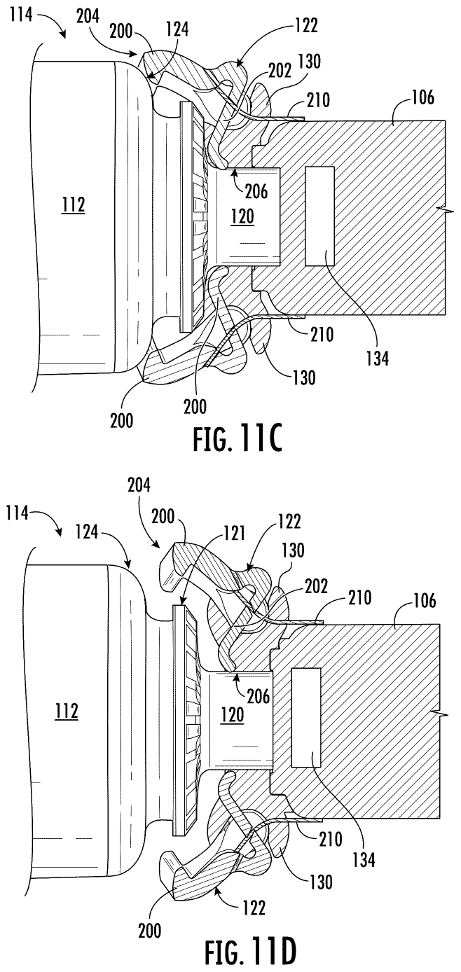

Turning to FIG. 8, provided is a perspective view of an example latch of an example water filtration assembly coupled to an example filter. In general, latch 122 may engage filter 114 to secure filter 114 to manifold 106. For example, as seen in FIG. 11B, latch 122 of manifold 106 engages ridge 121 of filtration housing 112 in a first position (e.g., FIG. 11B illustrates the first position of filter 114) in order to securely mount filtration housing 112, e.g., filter 114, within cabinet 20 of refrigerator appliance 10. Furthermore, as described in greater detail below, translating filter housing 112 from the first position to a second position (e.g., the second position is illustrated in FIG. 11C), latch 122 of manifold 106 engages shoulder 124 of filtration housing 112, thus generally positioning latch 122 in an open position (e.g., clear from obstructing ridge 121 of filtration housing 112) and freeing filtration housing 112 from manifold 106. As will be described further below, latch 122 may include a biasing element 210 configured to bias latch downwards, e.g., toward filtration assembly 112, in the first position, and upwards, e.g., away from filtration assembly 112, in the second position.

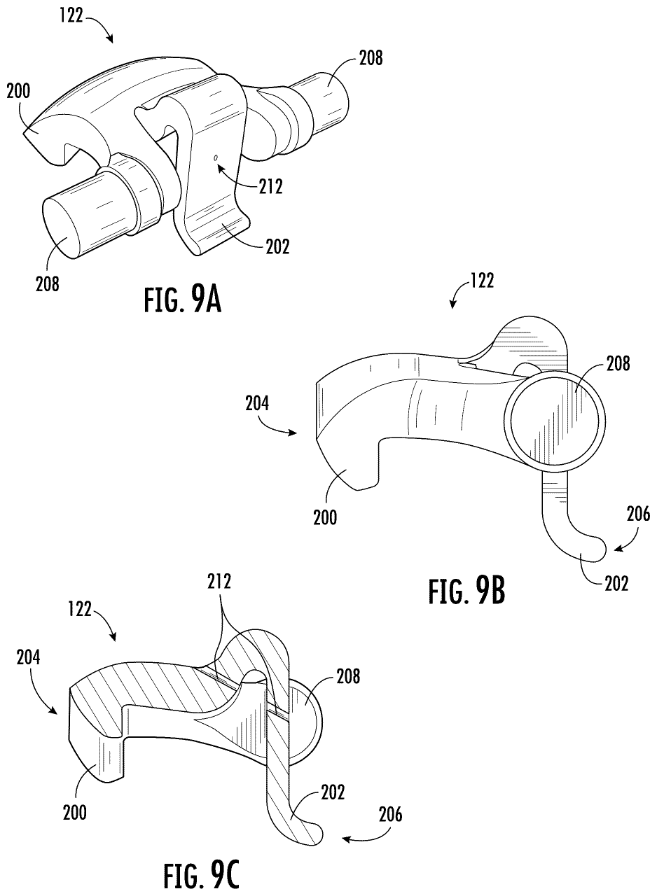

Referring now to FIGS. 9A, 9B, and 9C, provided are various views of an example latch 122 of the example water filtration assembly 102. In particular, FIG. 9A provides a perspective view of the latch 122 shown in FIG. 8, FIG. 9B provides a side view of the latch 122, and FIG. 9C provides a section view of the latch 122 of FIG. 9B. In general, latch 122 includes a hook 200 positioned at a first end 204 of latch 122 and an over-center spring 202 positioned at a second end 206 of latch 122. For example, over-center spring 202 may be integrally formed from/with hook 200, such that hook 200 and over-center spring 202 are a singular piece construction. In general, latch 122 may include a hole 212 through over-center spring 202 and a portion of hook 200. Referring briefly to FIG. 8, biasing element 210, may extend through hole 212 and extend outwards from second side 206 of latch 122. In the present example embodiment, biasing element 210 of latch 122 may include a return spring, such as a wire. For example, the return spring engages an outer surface 138 of manifold 106 to bias latch 122 in a desired direction, as described below.

In general, with regards to the first position and the second position, over-center spring 202 and biasing element 210 generally form a bistable system with two stable equilibrium states. For example, latch 122 may generally be toggled between the equilibrium states by translating filter 114 between the first position and the second position, as will be explained further below. One of skill in the art would generally understand the concept of bistable systems and as such further description of bistable systems will be omitted for the sake of brevity.

Referring generally to FIG. 8 and FIGS. 9A, 9B, and 9C, latch 122 generally includes one or more pivot ends 208 extending outwards from latch 122, e.g., perpendicularly from hook 200 and over-center spring 202. In general, pivot arm(s) 208 may be cylindrical protrusions, such as pegs or other rounded protuberance, configured to rotatably couple to one or more mounting arms 130 of manifold 106. For example, mounting arm(s) 130 may extend from an outer surface 138 of manifold 106 proximate to, e.g., adjacent to, a front side 107 of manifold 106. Mounting arm(s) 130 may generally receive pivot arm(s) 208 of latch 122, such as within holes (no labeled) defined by mounting arm(s) 130.

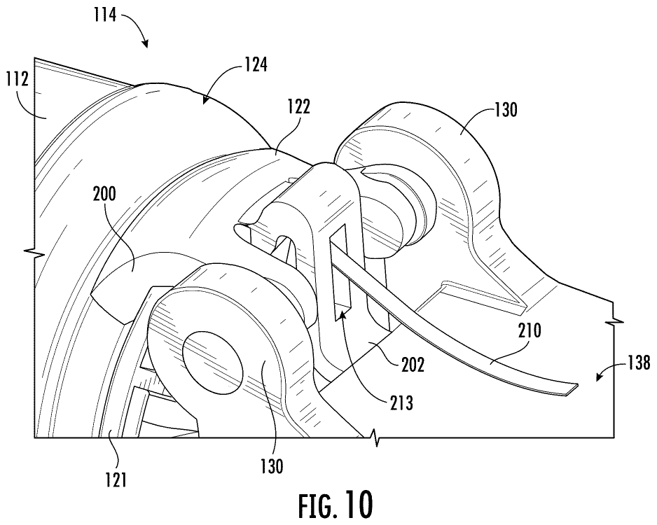

Turning briefly to FIG. 10, an alternative example embodiment for the return spring is provided. For example, the alternative example embodiment includes leaf spring for biasing element 210. In general, latch 122 includes a slot 213 (e.g., in place of hole 212) defined through one or more of hook 200 and over-center spring 202, where the leaf spring extends through slot 213 of latch 122 to engage the outer surface 138 of manifold 106.

Turning to FIGS. 11A, 11B, 11C, and 11D, illustrated are sequential stages of installing and removing a filter 114 from manifold 106, according to aspects of the present subject matter. In particular, FIG. 11A illustrates a side view of an example filtration housing before installing into an example manifold according to aspects of the present subject matter. In general, FIG. 11A provides a first stage of installing filter 114 into manifold 106. In particular, the first stage may generally include aligning, such as by a user, filter 114 with manifold 106, e.g., positioning filter port 120 in line with port 109 of manifold 106. In the present example embodiment, manifold 106 is illustrated with two (2) latches 122, however, one of skill in the art would understand that manifold may include one (1) or more latches 122 spaced circumferentially around manifold 106 configured to engage filter 114. For example, manifold may include between one (1) latch and six (6) latches, such as between two (2) latches and five (5) latches, such as between three (3) latches and four (4) latches.

FIG. 11B provides a side view of the example filtration housing of FIG. 11A in a first position, e.g., illustrating a second stage of installing filter 114 into manifold 106. In particular, the second stage of installing filter 114 into manifold 106 includes inserting filter port 120 into port 109 of manifold 106, where, as a result, latch 122 may slide over ridge 121 of filtration housing 112 and engage hook 200 of latch 122 over ridge 121, thus securing filter 114 to manifold 106. Further, manifold 106 may include an internal spring 134 within port 109. For example, when in the first position, internal spring 134 may bias filter 114 back away from manifold 106, thus maintaining engagement of ridge 121 of filtration housing 112 with hook 200 of latch 122 of manifold 106. In general, in the first position, biasing element 210 is in a first equilibrium position, where biasing element 210 is biasing hook 200 downwards (or otherwise towards the filter, depending on the position and orientation of the latch, e.g., the second, lower, latch 122 illustrated in FIG. 11B would be biased upwards in the first equilibrium position) over ridge 121 of filtration housing 112.

FIG. 11C provides a side view of the example filtration housing of FIG. 11A in a second position. In particular, FIG. 11C illustrates a side view of filter 114 and manifold 106 after installation, where filter 114 is being translated forward to the second position, e.g., further towards manifold 106, thus beginning a first stage of removing filter 114 from manifold 106. For example, when filter 114 is in the second position, biasing element 210 is in a second equilibrium position, where biasing element 210 is biasing hook 200 upwards away from ridge 121 of filtration housing 112.

In particular, pushing filter 114 further towards manifold 106 engages shoulder 124 against hook 200, where first side 204 of latch 122 is then rotated, about pivot ends 208, upwards, e.g., away from filtration housing 112. As a result, latch 122 overcomes a center, e.g., the center state between the equilibrium positions, of biasing element 210. For example, when latch 122 is rotated away from filtration housing 112, over-center spring 202 generally engages an outer surface (not labeled) of filter port 120, engaging biasing element 210 past the center between the first equilibrium position and the second equilibrium position, and into the second equilibrium position. As such, latch 122 is then held open in the open position, e.g., biased upwards away from filtration housing 112, so that filter 114 may be removed from manifold 106.

FIG. 11D provides a side view of the example filtration housing of FIG. 11A being removed from the example manifold. In general, FIG. 11D illustrates a second stage of removing filter 114 from manifold 106. As described above, during the first stage of removing filter 114, latch 122 is held open in the open position, e.g., by biasing element 210 in the second equilibrium position, and as such, during the second stage of removing filter 114, filter 114 may be pulled free from manifold 106, removing filter port 120 from port 109 of manifold 106. In general, when reinstalling filter 114, such as replacing filter 114 with a new filter 114, filter port 120 may engage over-center spring 202 of latch 122 when filter 114 is pushed into the first position, thus engaging biasing element 210 past the center between the second equilibrium position and the first equilibrium position, and into the first equilibrium position, where biasing element 210 biases hook 200 of latch 122 downwards toward filtration housing 112 and over ridge 121.

As may be seen from the above, a refrigerator water filter system includes an over-center toggle spring that latches and unlatches a removable filter to a manifold. Latching and unlatching the filter includes an interaction between a hook on the manifold, and an interface features on filter housing. The latch/hook includes a pivot end, a hook end, an integrated over-centered spring, and a return spring. The over-centered spring and a return spring work in tandem to provide a bistable system, which aids the engaging of the hook ends with the mating features on the filter when a user pushes the filter towards the manifold. When removing the filter, a user may push the filter further where as a result the latch hook slides open, and the over center spring changes the pivot positions. With the changed pivot position, the filter slides out, and the latch hook remains open to allow the filter to be removed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance defining a vertical direction, a lateral direction, and a transverse direction, the vertical, lateral, and transverse directions mutually perpendicular, the refrigerator appliance comprising:
a cabinet;
a dispensing assembly;
a manifold mounted within the cabinet and fluidly coupled to the dispensing assembly, the manifold comprising a latch and a port at a first end of the manifold, the latch comprising a biasing element; and
a filtration housing configured to couple to the manifold, the filtration housing comprising a ridge and a shoulder at a first end of the filtration housing,
wherein the latch of the manifold engages the ridge of the filtration housing in a first position securely mounting the filtration housing within the cabinet, and
wherein the filtration housing is configured to translate from the first position to a second position, wherein the latch of the manifold engages the shoulder of the filtration housing in the second position, whereby the latch overcomes a center of the biasing element, positioning the latch in an open position, and freeing the filtration housing from the manifold.

2. The refrigerator appliance of claim 1, wherein the latch comprises a hook positioned at a first end of the latch and an over-center spring positioned at a second end of the latch.

3. The refrigerator appliance of claim 2, wherein the over-center spring is integrally formed from the hook, the hook and the spring forming a singular piece.

4. The refrigerator appliance of claim 2, wherein the latch comprises one or more pivot ends extending outwards from the latch.

5. The refrigerator appliance of claim 4, wherein the one or more pivot ends rotatably couple to mounting arms of the manifold.

6. The refrigerator appliance of claim 2, wherein the biasing element of the latch comprises a return spring, the return spring engaged with an outer surface of the manifold.

7. The refrigerator appliance of claim 6, wherein the return spring comprises a wire, wherein the latch comprises a hole defined through both of the hook and the over-center spring, the wire extending through the hole of the latch.

8. The refrigerator appliance of claim 6, wherein the return spring comprises a leaf spring, wherein the latch comprises a slot defined through both of the hook and the over-center spring, the leaf spring extending through the slot of the latch.

9. The refrigerator appliance of claim 1, wherein the manifold comprises an internal spring within the port.

10. The refrigerator appliance of claim 9, wherein, when in the first position, the internal spring maintains engagement of the ridge of the filtration housing with the latch of the manifold.

11. A refrigerator appliance, comprising:
a cabinet;
a manifold mounted within the cabinet, the manifold comprising a latch and a port at a first end of the manifold, the latch comprising a biasing element; and
a filtration housing configured to couple to the manifold, the filtration housing comprising a ridge and a shoulder at a first end of the filtration housing,
wherein the latch of the manifold engages the ridge of the filtration housing in a first position securely mounting the filtration housing within the cabinet, and
wherein the filtration housing is configured to translate from the first position to a second position, wherein the latch of the manifold engages the shoulder of the filtration housing in the second position, whereby the latch overcomes a center of the biasing element, positioning the latch in an open position, and freeing the filtration housing from the manifold.

12. The refrigerator appliance of claim 11, wherein the latch comprises a hook positioned at a first end of the latch and an over-center spring positioned at a second end of the latch.

13. The refrigerator appliance of claim 12, wherein the over-center spring is integrally formed from the hook, the hook and the spring forming a singular piece.

14. The refrigerator appliance of claim 12, wherein the latch comprises one or more pivot ends extending outwards from the latch.

15. The refrigerator appliance of claim 14, wherein the one or more pivot ends rotatably couple to mounting arms of the manifold.

16. The refrigerator appliance of claim 12, wherein the biasing element of the latch comprises a return spring, the return spring engaged with an outer surface of the manifold.

17. The refrigerator appliance of claim 16, wherein the return spring comprises a wire, wherein the latch comprises a hole defined through both of the hook and the over-center spring, the wire extending through the hole of the latch.

18. The refrigerator appliance of claim 16, wherein the return spring comprises a leaf spring, wherein the latch comprises a slot defined through both of the hook and the over-center spring, the leaf spring extending through the slot of the latch.

19. The refrigerator appliance of claim 11, wherein the manifold comprises an internal spring within the port.

20. The refrigerator appliance of claim 19, wherein, when in the first position, the internal spring maintains engagement of the ridge of the filtration housing with the latch of the manifold.
